(19) United States
(12) Patent Application Publication
(10) Pub. No.: US 2013/0229714 A1
(43) Pub. Date: Sep. 5, 2013

(54) LENS ARRAY, IMAGE FORMING DEVICE AND METHOD FOR MANUFACTURING LENS ARRAY

(71) Applicant: TOSHIBA TEC KABUSHIKI KAISHA, Tokyo (JP)

(72) Inventors: Atsushi KUBOTA, Shizuoka (JP); Ryozo AKIYAMA, Shizuoka (JP)

(73) Assignee: Toshiba Tec Kabushiki Kaisha, Tokyo (JP)

(21) Appl. No.: 13/784,287

(22) Filed: Mar. 4, 2013

(30) Foreign Application Priority Data
Mar. 5, 2012 (JP) 2012-048146

(51) Int. Cl. G02B 3/00; B05D 3/06

(52) U.S. Cl. CPC G02B 3/005; B05D 3/067
USPC 359/601; 427/558

(57) ABSTRACT

According to one embodiment, a lens array includes a substrate with a lens surface having a plurality of lenses and a side surface, and a light-blocking film that is arranged between the plurality of lenses on the lens surface. A curing light is provided to the lens surface as well as to the inside of the substrate through the side surface to cure the light-blocking film.

### CROSS-REFERENCE TO RELATED APPLICATION

This application is based upon and claims the benefit of priority from Japanese Patent Application No. 2012-048146, filed Mar. 5, 2012; the entire contents of which are incorporated herein by reference.

### FIELD

Embodiments described herein relate generally to a lens array having a light-blocking film provided between a plurality of lenses, an image forming device, and a method for manufacturing a lens array.

### BACKGROUND

A light-blocking film for preventing stray light has been included in many lens arrays used in image forming devices such as printers, copiers, multifunction peripherals (MFP), fax machines, and scanners; or liquid crystal display devices, solid-state imaging devices, multiple image transfer by optical interconnection, confocal laser microscopes, or, in the field of optical communications, optical disks, image displays, image transmission and coupling, optical metrology, optical sensing, optical processing, and the like.

However, lens arrays having a light-blocking film made of ultraviolet curable ink (that cures using ultraviolet light) suffer drawbacks. As examples, the UV curable ink blocks ultraviolet light from the lens array, and the UV curable ink is unable to cure sufficiently.

### DESCRIPTION OF THE DRAWINGS

FIG. 1 is a schematic diagram illustrating a first embodiment of an image forming device.

FIG. 2 is a schematic diagram illustrating a black (K) image formation section according to the first embodiment.

FIG. 3 is a schematic diagram illustrating an image sensor according to the first embodiment.

FIG. 4 is a schematic top view diagram illustrating a lens array according to the first embodiment.

FIG. 5 is a schematic illustration of a lens array seen from the line d-d′ in FIG. 4.

FIG. 6 is a schematic diagram of a light-shield film forming device according to the first embodiment.

FIG. 7 is a schematic diagram of an apparatus for the irradiation of ultraviolet light according to the first embodiment.

FIG. 8 is a schematic diagram of a substrate on a conveyance stage according to a method for manufacturing the light-blocking film according to the first embodiment.

FIG. 9 and FIG. 10 are schematic diagrams for explaining the ejection of ultraviolet curable ink according to embodiments of a method for manufacturing the light-blocking film according to the first embodiment blocking

FIG. 11 is a schematic diagram illustrating the completion of forming the light-blocking film in the method for manufacturing the light-blocking film according to the first embodiment.

FIG. 12 is a schematic diagram of a portion of a light-blocking film forming device according to a second embodiment.

FIG. 13 is a schematic diagram of the irradiation of ultraviolet light onto an ultraviolet curable ink according to the second embodiment.

FIG. 14 is a schematic diagram of the irradiation of ultraviolet light onto the ultraviolet curable ink according to the second embodiment.

FIG. 15 is a schematic diagram of the irradiation of ultraviolet light onto the ultraviolet curable ink according to a third embodiment.

FIG. 16 is a perspective view of a portion of a lens array according to the third embodiment.

FIG. 17 is a schematic diagram of an alternative embodiment for the irradiation of ultraviolet light onto an ultraviolet curable ink according to the third embodiment.

FIG. 18 is a schematic diagram of another alternative embodiment for the irradiation of ultraviolet light onto an ultraviolet curable ink on the first lens surface according to the third embodiment.

FIG. 19 is a schematic diagram of another alternative embodiment for the irradiation of ultraviolet light onto an ultraviolet curable ink on the second lens surface according to the third embodiment.

### DETAILED DESCRIPTION

Embodiments disclosed herein provide a lens array and an image forming device, and a method for manufacturing the lens array, which lens array irradiates ultraviolet light onto an ultraviolet curable ink sufficiently to completely cure the ultraviolet curable ink.

In general, according to one embodiment, a lens array that achieves the effects of the embodiments will be explained referring the drawings. Identical references will be used for identical parts in each drawing and for brevity; the explanation for the elements will not be repeated.

According to one embodiment, a lens array includes: a substrate including a lens surface having a plurality of lenses; a protruding plane that protrudes from an end portion of the lens surface; and a light-blocking film arranged between the plurality of lenses on the lens surface.

### First Embodiment

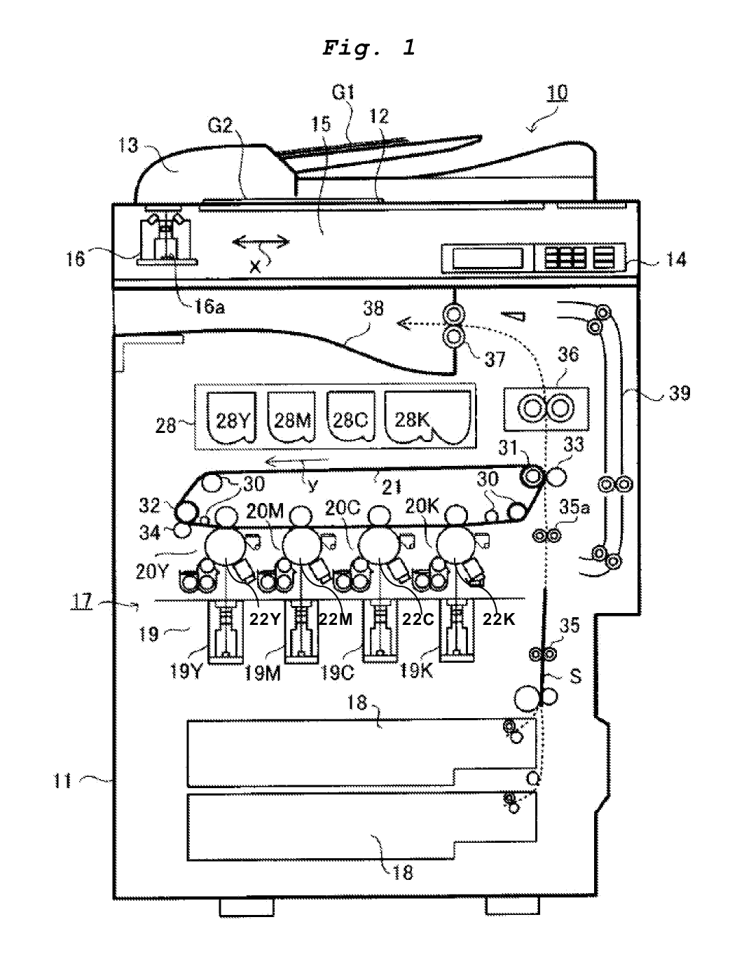

A first embodiment will be explained referring to FIG. 1 to FIG. 11. FIG. 1 illustrates a color MFP (Multi-Function Peripheral) 10 as an image forming device in the first embodiment. A platen 12 made with transparent glass is provided on top of a main body 11 of the MFP 10, and an auto document feeder (ADF) 13 on the platen 12 can be freely opened or closed. An operating panel 14 is provided at the upper portion of the main body 11. The operating panel 14 has a variety of keys and a touch-panel display.

A scanner unit 15, which is an image reading device, is provided below the lower portion of the ADF 13 inside the main body 11. The scanner unit 15 scans a document G1 fed by the ADF 13, or a document G2 placed on the platen 12, and generates image data. A contact image sensor 16a is incorporated in an image reading unit 16. The image sensor 16a is arranged in a main scanning direction (into the paper in FIG. 1). The image-scanning device 16 includes a light source. Light from the light source is irradiated onto the document G2 placed on the platen. The light is reflected by the document G2 and passes a lens array before reaching the image sensor 16a. The image sensor 16a is at a fixed position shown in FIG. 1, when scanning a document fed by the ADF 13.

A printer unit 17 is provided at the center portion inside the main body 11. A plurality of cassettes 18 that contain various sizes of paper are provided at the lower portion of the main body 11. The printer unit 17 has a photosensitive drum and a scanning bed 19 including a LED as an exposure device, and generates an image by scanning the photosensitive drum using a light beam from the scanning head 19.

The printer unit 17 generates images on a paper by processing image data that is scanned by the scanner unit 15, or the image data that is generated by a PC (Personal Computer) or the like. The printer unit 17 can be a tandem color laser printer, for example, including image forming units 20Y (yellow), 20M (magenta), 20C (cyan) and 20K (black). The image forming units 20Y, 20M, 20C and 20K are provided below an intermediate transfer belt 21 in a parallel arrangement from the upstream side to the downstream side of the intermediate transfer belt 21. The scanning bed 19 also has multiple scan heads 19Y (yellow), 19M (magenta), 19C (cyan) and 19K (black) corresponding to the image forming units 20Y, 20M, 20C and 20K.

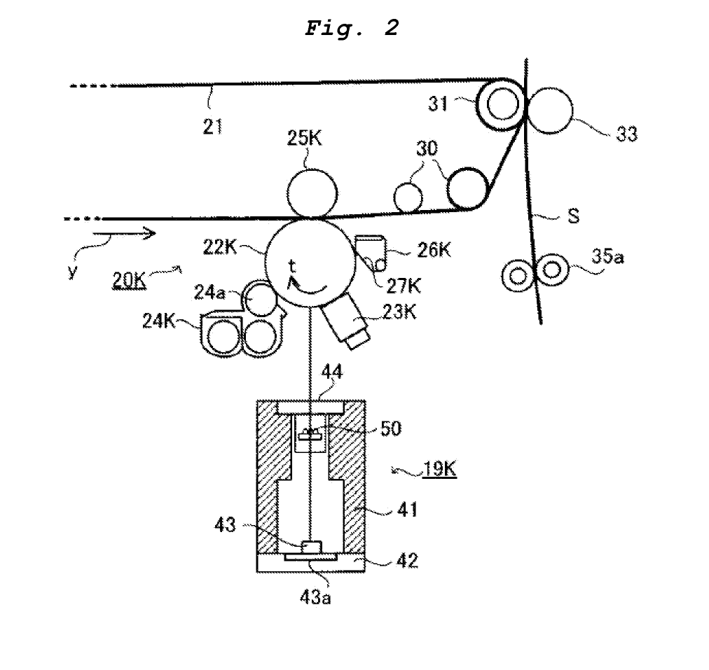

FIG. 2 illustrates the black (K) image forming unit 20K out of the image forming units 20Y, 20M, 20C and 20K shown in FIG. 1. Hereafter, the image forming unit 20K will be explained as a representative, because each of the image forming units 20Y, 20M, 20C and 20K has the same configuration with the exception of the color configuration.

The image forming unit 20K has a photosensitive drum 22K as an image-carrying member. An electrostatic charging unit 23K, a developing unit 24K, a primary transferring roller 25K, and a cleaner 26K having a blade 27K are arranged around the photosensitive drum 22K in the direction of rotation t. The scan head 19K irradiates a light to an exposure spot on the photosensitive drum 22K and forms an electrostatic latent image on the photosensitive drum 22K.

The electrostatic charging unit 23K of the image forming unit 20K charges the surface of the photosensitive drum 22K. The developing unit 24K supplies a black toner to the photosensitive drum 22K by a developing roller 24a to which a developing bias is applied. The cleaner 26K cleans up the residual toner on the surface of the photosensitive drum 22K using the blade 27K.

As illustrated in FIG. 1, toner cartridges 28Y (yellow), 28M (magenta), 28C (cyan) and 28K (black) that supply toner to the image forming units 20Y, 20M, 20C and 20K are provided at the top of the image forming units 20Y, 20M, 20C and 20K.

The intermediate transfer belt 21 is extended through a drive roller 31, a driven roller 32 and a tension roller 30, and circulates in the direction of the arrow y. Also, a portion of the intermediate transfer belt 21 is faces and touches the photosensitive drums 22Y (yellow), 22M (magenta), 22C (cyan) and 22K (black) of the image forming units 20Y, 20M, 20C and 20K. By the coupling or contact of the intermediate transfer belt 21 with the primary transferring roller 25K (shown in FIG. 2), a primary transfer voltage is applied to the position on the intermediate transfer belt 21 that is facing the photosensitive drum 22K. A toner image on the photosensitive drum 22K is then transferred to the intermediate transfer belt 21.

A secondary transferring roller 33 is provided to face the driving roller 31 that provides motion to the intermediate transfer belt 21. When a paper or other printing medium sheet S passes between the driving roller 31 and the secondary transferring roller 33, a secondary transfer voltage is applied to the paper sheet S by the secondary transferring roller 33, and toner images on the intermediate transfer belt 21 are thereby transferred to the paper sheet S. A belt cleaner 34 is provided adjacent the driven roller 32 of the intermediate transfer belt 21, in a position relative to the transfer of the belt such that the remnants of a latent image on the intermediate belt 21 which were transferred to the sheet S are removed from the intermediate belt 21 before that portion of the intermediate belt reaches the latent image writing position of the first photosensitive drum and a scanning bed 19Y of the printing unit 17.

As illustrated in FIG. 1, conveying rollers 35, which convey the paper sheet S taken from a paper feed cassette 18, and a resist roller 35a, are provided between the paper feed cassette 18 and the secondary transferring roller 33. In addition, a fixing unit 36 is provided downstream of the secondary transferring roller 33 to fix an image on the sheet. Paper discharge rollers 37 are provided downstream of the fixing device 36. The paper discharge rollers 37 eject the paper sheet S to a discharge section 38.

A reverse conveying path 39 is provided downstream of the fixing unit 36. The reverse conveying path 39 reverses the paper sheet S and guides the paper sheet S towards the secondary transferring roller 33 when performing duplex, i.e., two sided, printing.

The scan head 19K illustrated in FIG. 2 faces the photosensitive drum 22K. The photosensitive drum 22K rotates at a predetermined speed and stores an electrical charge on its surface. Alight from the scan head 19K is irradiated onto the photosensitive drum 22K, exposing the photosensitive drum 22K and forming an electrostatic latent image on the surface of the photosensitive drum 22K.

The scan head 19K has a lens array 50, and the lens array 50 is supported by a holding member 41. A support 42 is provided at the bottom of the holding member 41. The support 42 has a plurality of LED elements 43 as a light source (only one is shown in the side view of FIG. 2). The LED elements 43 are provided in the main scanning direction (toward the paper) and are equally spaced in a linear fashion in the direction of belt motion past the scan head 19K. A control substrate 43a including a driver IC to control emission of the LED 43 is provided on the support 42.

The control substrate 43a generates control signals for the scan head 19K based on image data to cause light to be emitted from the LED element 43 at a certain light intensity based on the control signals. The light emitted from the LED element 43 passes through the lens array 50 and forms an electrostatic latent image on the photosensitive drum 22K. The scan head 19K has a cover glass 44 at the top portion of the holding member 41 (the irradiating side).

Referring to FIGS. 1 and 3, as an image on a document, such as a sheet of paper, passes the image reading unit 16, the image sensor 16a thereof scans images of the document G2 (shown in FIG. 1) placed on the platen 12, or the document G1 fed by the ADF 13 (shown in FIG. 1), in accordance with an operation of the operating panel 14 (shown in FIG. 1). The image sensor 16a is a one-dimensional sensor arranged in the main scanning direction (into the paper). Two LED line lighting systems 47 and 48, which illuminate towards the documents, are arranged in the main scanning direction (into the paper) on the top surface of a chassis 45, that is provided on a substrate 46 below the platen 12, to illuminate any image on the document. The light source for illuminating documents is not restricted to an LED, and a fluorescent tube, a xenon tube, a cold-cathode tube, or an organic EL can be also used.

A lens array 50 is supported in between the LED line lighting systems 47 and 48 at the upper portion of the chassis 45. An image sensor 49, comprised of CCD and CMOS, is mounted on the substrate 46 located at the bottom of the chassis 45. The LED line lighting systems 47 and 48 illuminate the image scanning position of a document on the platen 12, and the light reflected at the image scanning position enters the lens array 50. The lens array 50 functions as an erecting equal-magnification lens. Light that enters the lens array 50 is passed from the plane of the lens array 50 and forms an image on the image sensor 49. The light that forms an image is converted to electric signals by the image sensor 49 and is transferred to a memory unit (not shown) of the substrate 46.

As an image forming device, an MFP (Multi-Function Peripheral) is used as an example and explained in this embodiment, although an image forming device is not restricted to an MFP. A stand-alone printer, or a stand-alone scanner, can also be an image forming device.

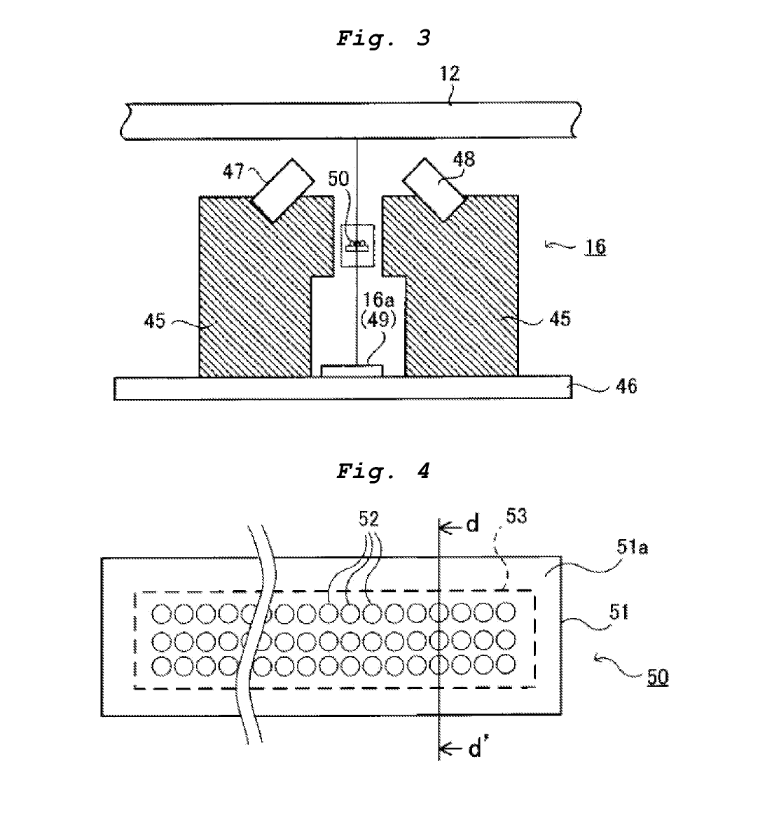

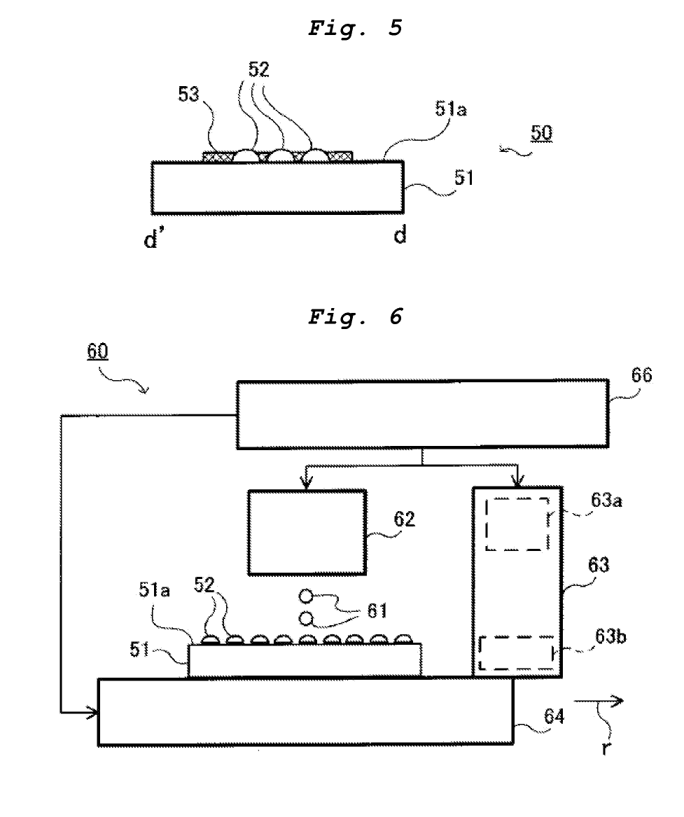

The lens array 50 will be explained in detail next. As illustrated in FIG. 4 and FIG. 5, the lens array 50 includes a transparent substrate 51 having a plurality of lenses 52 on a lens surface 51a, and a light-blocking film 53, in this example 24 μm thick, which is formed on the lens surface 51a between each lens 52. The substrate 51 having the lenses 52 can be formed by molding a transparent material into the shape of a generally flat substrate 51 having individual lenses 52 protruding from a surface thereof. The light-blocking film 53 is formed on the substrate 51, between the individual lens elements 53, using a light-blocking film forming device 60, illustrated in FIG. 6. The light-blocking film forming device 60 forms the light-blocking film 53 by ultraviolet curing of ink applied by an inkjet method. The light-blocking film forming device 60 includes an inkjet printing unit 62, ultraviolet irradiating device 63, a conveyor bed 64 and a control unit 66.

The conveyor bed 64 supports the substrate 51 having the plurality of lenses 52 thereon, and moves in the direction shown by the arrow r, and conveys the substrate 51 relative to the inkjet printing unit 62 and the ultraviolet irradiating device 63 (shown schematically in FIG. 6). The inkjet printing unit 62 ejects an ultraviolet curable ink 61 from above of the substrate 51 toward the space between each lens 52 on the lens surface 51a. The ultraviolet irradiating device 63 includes: a first irradiating section 63a that irradiates ultraviolet 67 from above of the lens surface 51a, and a second irradiating section 63b that irradiates ultraviolet 68 from a side plane 51b (shown in FIG. 7) of the substrate 51, which is perpendicular to the lens surface 51a. Ultraviolet curable ink 61 is ejected onto the lens surface 51a as illustrated in FIG. 7. The control unit 66 controls the inkjet printing unit 62, the ultraviolet irradiating device 63 and the conveyor bed 64. The control unit 66 controls the speed of the conveyor bed 64 and a timing of the conveyor. The control unit 66 controls an amount of ink ejected from the inkjet printing unit 62 for example. Control of an amount of ink ejected can be implemented by adjusting the voltage for ink ejection to change the drop size, for example, or by adjusting the number of droplets in a multi-drop method.

For the light-blocking film forming device 60, the ultraviolet curable ink 61 can be applied to the lens surface 51a by an ink-applying device instead of the inkjet method. Also, in order to form the light-blocking film 53, the inkjet printing unit 62 and the ultraviolet irradiating device 63 can move relative to the conveyor bed 64 and the substrate 51, instead of moving the conveyor bed 64 relative to the inkjet printing unit 62 and the ultraviolet irradiating device 63.

The ultraviolet curable ink will be explained. Example light-blocking materials for the ultraviolet curable ink will are listed below.

### Light-Blocking Material

As light-blocking material in order to form a light-blocking film between the plurality of lenses, optical insulating properties and reflecting properties are required to be considered. Consideration of flying capability (drop flight behavior), or dispersing stability, of the ink is required as an inkjet ultraviolet curable ink property; and light-absorbing pigments can be used as such a material. For example, carbon-based pigments, such as carbon black, refined carbon and carbon nanotubes; metallic oxide pigments such as iron black, zinc oxide, titanium oxide, chromium oxide and the iron oxide; sulfide pigments such as zinc sulfide; phthalocyanine pigments; salt pigments such as sulfate metal, carbonate, silicate and phosphate; metallic powder such as aluminum powder, bronze powder and zinc powder can be used.

### Reactive Material

A base material for the light-blocking film is a light curing material including: photopolymerizing reactive materials such as reactive monomers and oligomers having polymerizable functional groups, and a photo initiator that initiates polymerization thereof. Reactive materials can be categorized into radical types and cationic types, though various types are currently used for various purposes.

An acryl monomer or oligomer having an acryloyl functional group is representative of the radical type of reactive material which may be used; polymerization is accelerated by radicals, which are generated from a photo initiator after it is irradiated by energy such as light. Coating, ink, optical material, and resist can be used for its application. However, drawbacks associated with these materials, such as enzyme inhibition at the time of polymerization, and relatively larger volume contraction following curing, are issues that need to be controlled if these materials are used.

A cyclic ether compound represented by epoxy and an oxetane compound, or a vinyl ether compound having a vinyl ether group are representative of the cationic type of material which may be used. As a photo initiator, polymerization is initiated using electrons generated by irradiation to form an acid to react with the cyclic compound to form a polymer. A cyclic ether compound has minimal volume contraction during polymerization, which leads to superior adhesiveness to a base material. Polymerization can be implemented without enzyme inhibition; superior formability of a thin layer is also a different point compared to the radical type.

As a light-blocking film of a lens array, a material that satisfies the property of being capable of being formulated into ink ultraviolet curable ink in light of characteristics described above, and dispensed by inkjet printing, can be properly selected and used. An ink material for this embodiment has no particular limitation as long as the material has an insulating property, a reflecting or non-light transmissive property, suitable strength when cured, and may be cured using ultraviolet light blocking. The ink material should include physical properties, such as viscosity and surface tension, such that it may be used as an inkjet ultraviolet curable ink, as well as dispersion stability for use as light blocking materials, and compatibility with a head member in the inkjet printer. Tangible examples will be listed hereafter.

Radical type materials can be represented by a monomer such as monofunctional acrylate, difunctional acrylate, polyfunctional acrylate with three or more functional groups, and an oligomer such as polyester acrylate, urethane acrylate, epoxy acrylate, depending on the number of acryloyl groups in the molecule. Monofunctional monomer among these is often used as a reactive diluent, and plays an important role as viscosity adjusting material as an inkjet ink.

As a concrete example, isobornyl acrylate, acryloyl morpholine, dicyclopentadienyl acrylate, an acrylic acid adduct of phenyl glycidyl ether, 2-hydroxyethyl acrylate, 2-hydroxypropyl acrylate, 2-hydroxybutyl acrylate, 2-hydroxyhexyl acrylate, ethyl carbitol acrylate, tetrahydrofurfuryl acrylate, 2-acryloyloxyethyl phthalate, benzyl acrylate, and methacryl acrylate such as a 2-hydroxyhexyl metacrylate, allyl metacrylate, a benzyl metacrylate, cyclohexyl metacrylate, may be used.

As a difunctional acrylate, neopentyl glycol diacrylate, nonanediol diacrylate, tripropylene glycol diacrylate, tricyclodecane dimethanol diacrylate, EO adduct acrylate of the bisphenol A; as a polyfunctional acrylate, trimethylol propane triacrylate, pentaerythritol triacrylate, dipentaerythritol pentaacrylate, triacrylate of the isocyanuric acid EO adduct, can be listed. Other than acrylate system, N-vinyl pyrrolidone and N-vinyl caprolactam can be useful as a diluent.

Epoxy compound, oxetane compound and vinyl ether compound can be used as cationic type materials.

A hydrocarbon group having an aliphatic backbone of 2 values or an alicyclic backbone, and the compound which has an epoxy group or an alicyclic epoxy group in one or both of the basis of 2 values to have an aliphatic chain or an alicyclic backbone can be used as epoxy compounds. For example, alicyclic epoxy represented by CELLOXIDE 2021, CELLOXIDE 2021A, CELLOXIDE 2021P, CELLOXIDE 2081, CELLOXIDE 2000, CELLOXIDE 3000 from DAICEL CORPORATION, (meta)acrylate compound having epoxy group such as CYCLOMER A200, CYCLOMER M100, metacrylate having methyl glycidyl group such as MGMA, low molecular epoxy compound such as glycidol, β-methylepichlorohydrin, α-Pinene oxide, α-olefin monoepoxide of C12 to C14, α-olefin monoepoxide of C16 to C18, epoxidized soybean oil such as DAIMAC S-300K, epoxidized linseed oil such as DAIMAC L-500, polyfunctional epoxy such as EPOLEAD GT301 and EPOLEAD GT40, can be used.

In addition, alicyclic epoxy from the Dow Chemical Company in the U.S. such as CYRACURE; a compound, of which the hydroxyl group end of low molecule phenolic compounds which are hydrogenated and made aliphatic is substituted with a group having epoxy; polyvalent aliphatic alcohol such as ethylene glycol, glycerin, neopentyl alcohol, hexanediol, and trimethylolpropane; glycidyl ether compound such as alicyclic alcohol; glycidyl ester such as hexahydrophthalic acid and polyvalent carboxylic acid of hydrogenated aromatic series; can be used.

As an oxetane compound, for example, di[1-ethyl(3-oxetanyl)]methyl ether, 3-ethyl-3-(2-ethylhexyloxymethyl)oxetane, [(1-ethyl-3-oxetanyl)methoxy]cyclohexane, bis[(1-ethyl-3-oxetanyl)methoxy]cyclohexane, compound in which one or more groups containing oxetane are introduced to an alicyclic ring such as bis[(1-ethyl-3-oxetanyl)methoxy]norbornane, an ether compound which dehydration synthesize alcohol including oxetane such as 3-ethyl-3-hydroxymethyl oxetane to aliphatic polyvalent alcohol such as ethylene glycol, propylene glycol and neopentyl alcohol, can be listed. Also, as an oxetane compound including aromatic backbone, for example, 1,4-bis((1-ethyl-3-oxetanyl)methoxy)benzene, 1,3-bis((1-ethyl-3-oxetanyl)methoxy)benzene, 4,4′-bis((3-ethyl-3-oxetanyl)methoxy)biphenyl, phenol novolac oxetane, can be listed.

As a vinyl ether compound, 2-ethylhexyl vinyl ether, buntanediol vinyl ether, cyclohexanedimethanol divinyl ether, cyclohexanedimethanol monovinyl ether, dithylene glycol monovinyl ether, dithylene glycol divinyl ether, hexanediol divinyl ether, triethyleneglycol divinyl ether, 4-hydroxybutyl vinyl ether can be listed. It may be preferable to combine a vinyl ether compound with an oxetane compound or epoxy compound, which may be represented in the formula (1) below, solely or in combination into a liquid ink, in case improvement of curing hardness and further decrease in viscosity in addition to an improvement of curing speed are required.

Vinyl ether compounds bound to methylene group, such as aliphatic glycol derivatives and cyclohexane dimethanol, are inappropriate for use as inkjet dispersible materials due to a severe inhibition of polymerization by a pigment. However, a compound that is shown in formula (1) below has vinyl ether group directly on an alicyclic backbone, terpenoid backbone, or aromatic backbone and has superior curing properties even if combined together with a pigment. The blending quantity of these compounds is provided in a ratio of 50 parts by weight or less in order to maintain heat plasticity. However, the quantity can be up to a total amount of solvent that cures by acid, when higher solvent resistance and hardness are required, even if losing heat plasticity. The proportion of the compound may be 50 parts by weight, or less, to maintain the thermoplastic property of the liquid ink. When greater solvent resistance and hardness are required, the proportion may be further increased to the entire quantity of the solvent to be cured by acid, even though some degradation in the thermoplastic property may occur.

R13−R14−(R13)p Formula (1)

In the formula (1) above, one of the R13 is at least a vinyl ether group; having a substituent group selected from a vinyl ether group and a hydroxyl group. R14 is a (p+1)-valent group selected from alicyclic backbone, or a backbone having an aromatic ring, where p is a positive integer including 0. When R14 is cyclohexane backbone and also p is 0, at least one of the carbons on the nucleus has ketone structure. As an organic group R14 of (p+1)-valent, for example, (p+1)-valent group including a benzene ring, a naphthalene ring, and a biphenyl ring; and induced (p+1)-valent group including a cycloalkane backbone, norbornane backbone, adamantane backbone, tricyclodecane backbone, tetracyclo dodecane backbone, terpenoid backbone, and cholesterol backbone, can be listed.

More specifically, alicyclic polyols such as cyclohexane(poly)ol, norbornane(poly)ol, tricyclodecane (poly) ol, adamantane (poly) ol, benzene (poly) ol, naphthalene(poly)ol, anthracene(poly)ol, and biphenyl(poly)ol, or compounds in which hydrogen atoms of the hydroxyl group in phenol derivatives are substituted to vinyl group can be listed. In addition, compounds in which hydrogen atoms of the hydroxyl group in polyphenol compound such as polyvinyl phenol and phenol novolac are substituted with vinyl group. The compounds above can be used extensively due to a reduction of volatility, even if a part of hydroxyl group remains, or a part of methylene atom of alicyclic backbone is substituted to ketone group. Particularly, a cyclohexane ring that is at least oxidized to cyclohexanone ring when a cyclohexyl monovinyl ether compound is used, because cyclohexyl monovinyl ether compounds have a high volatility.

Next, example of a photo initiator can be categorized into a radical system and a cationic system. Common examples are listed.

A radical system can be a benzoin ether system, a acetophenone system, and a phosphine oxide system; cleavage type such as 1-hydroxycyclohexyl phenyl ketone, diethoxyacetophenone, 2-hydroxy-2-methyl-1-phenylpropan-1-one, 2-benzyl-2-dimethylamino-1-(4-morpholinophenyl)-butanone-1; hydrogen atom abstraction type such as benzophenone, 2,4-diethyl thioxanthone, isopropyl thioxanthone, can be listed.

A cationic system can be an onium salt, a diazonium salt, a quinone diazide compound, an organohalide, an aromatic sulfonate compound, a bisulphone compound, a sulfonyl compound, a sulfonate compound, a sulfonium compound, a sulfamide compound, an iodonium compound, a sulfonyl diazomethane compound and mixtures thereof.

More specifically, triphenylsulfonium triflate, diphenyliodonium triflate, 2,3,4,4-tetrahydroxybenzophenone-4-naphthoquinone diazido sulfonate, 4-N-phenylamino-2-methoxy phenyl diazonium sulfate, 4-N-phenylamino-2-methoxy phenyl diazonium p-ethylphenyl sulfate, 4-N-phenylamino-2-methoxy phenyl diazonium 2-naphthyl sulfate, 4-N-phenylamino-2-methoxy phenyl diazonium phenyl sulfate, 2,5-diethoxy-4-N-4′-methoxyphenyl carbonyl phenyl diazonium-3-carboxy-4-hydroxyphenyl sulfate, 2-methoxy-4-N-phenyl phenyldiazonium-3-carboxy-4-hydroxyphenyl sulfate, diphenylsulfonyl methane, diphenylsulfonyl diazomethane, diphenyl disulfone, α-methylbenzoin tosylate, pyrogallol trimethylate, benzoin tosylate, can be listed.

The ultraviolet curable ink 61 is made using these materials and by steps including a step dispersing a (light-blocking material) to monomers (reactive monomer) and a step of adding and mixing obtained dispersed liquid with an appropriate monomer, oligomer and photo initiator, and polymerization inhibitor as necessary, and a final purification step of filtration or centrifugation to remove coarse particles and unnecessary solid contents.

The polymerization inhibitor can be cationic system or radical system. Cationic system can be n-hexylamine, dodecylamine, aniline, dimethyl aniline, diphenylamine, triphenyl amine, diazabicyclooctane, diazabicyclo undecane, 3-phenylpyridine, 4-phenylpyridine, lutidine, 2,6-di-t-butyl pyridine. Radical system can be DPPH(1,1-diphenyl-2-picrylhydrazyl), TEMPO(2,2,6,6-tetramethylpiperidinyl-1-oxyl). p-benzoquinone, chloranil, nitrobenzene, hydroquinone (HQ), methyl hydroquinone (MEHQ), t-butyl catechol, dimethyl aniline.

As for a material property of the ultraviolet curable ink 61, there is no effect on the flying capability by the inkjet printing section 62, if an average particle diameter of insulating material is less than 300 nm. Viscosity values of the ultraviolet curable ink are provided in a range of 5 to 30 mPa·s at 25° C. Surface tension is set within a range of 22 to 40 mN/m. The viscosity value and the surface tension value of the ultraviolet curable ink 61 can be adjusted by a blend of monomer, oligomer or surfactant agent.

In order to distribute ink by itself to a narrow part between the lens surface 51a and each lens 52, a contact angle of the lens surface 51a of the substrate 51 and the ultraviolet curable ink is less than 20 degree at 25° C.

A method for forming the light-blocking film 53 using the ultraviolet curable ink 61 to form a light blocking film on the surface of the substrate 51 and between each lens 52 of the lens surface 51a is described referring FIG. 7 through FIG. 11. As a light blocking material or component in the ultraviolet curable ink 61 that is used for the light-blocking film 53, a light-blocking material can be carbon black, for example. Content of carbon black of the ultraviolet curable ink 61 is set to 3.5 wt %; the light-blocking film 53 is formed to be 24 μm thick. For the ultraviolet lights 67 and 68 (shown in FIG. 7) irradiated from the first irradiating section 63a and the second irradiating section 63b, respectively, of the ultraviolet irradiating unit 63, illumination intensity is set to 2000 mW/cm², integrated light quantity is set to 400 mJ/cm², and wave length is 365 nm.

Regarding the light-blocking film 53 of the lens array 50, the higher the light-blocking property is, the more stray light can be prevented, which is advantageous for the characteristics of the lens array 50. The light-blocking property of the light-blocking film 53 can be obtained by measuring optical density (transmission density). Measurement of optical density can be implemented using a 361T Densitometer from X-rite, for example. The light-blocking film 53 can block transmitted light nearly completely when the optical density is 6 or higher. (Optical density is a decadic logarithm of opacity; a larger extinction amount gives a larger value. Where optical density is 6, light penetration efficiency is 0.000001%.)

When carbon black is used as a light-blocking material of the light-blocking film 53, and the content of carbon black is 3.5 wt %, 24 μm thick or more of the light-blocking film 53 is required to have sufficient light-blocking property. When the content of carbon black is 7.5 wt %, 12 μm thick or more of the light-blocking film 53 is required to have sufficient light-blocking property. In order to obtain the light-blocking film 53 having sufficient light-blocking property, there are other ways of making the light-blocking film 53 thicker, or increasing the ratio by weight of a light-blocking material in the ultraviolet curable ink 61.

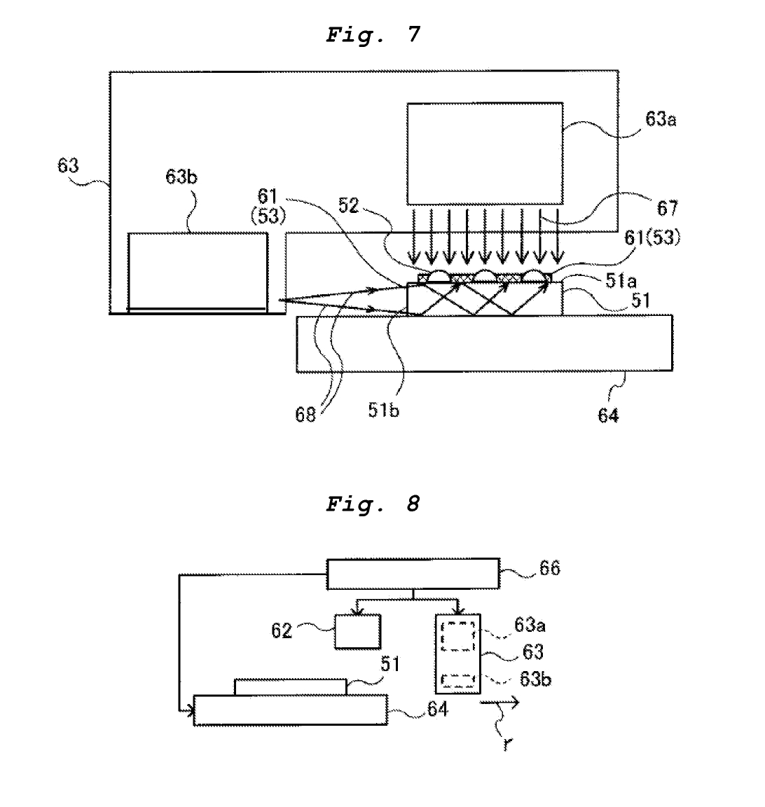

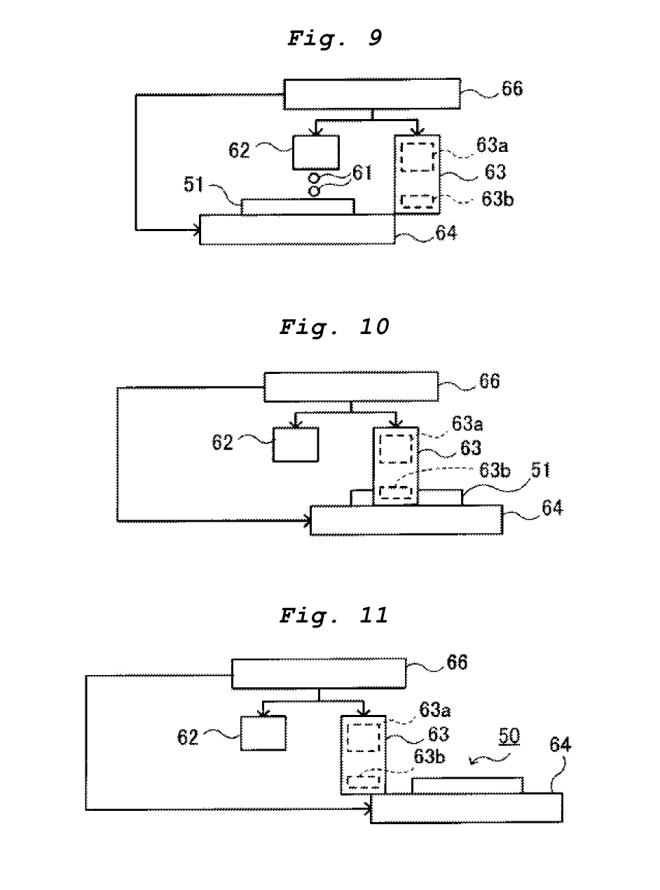

As illustrated in FIG. 8, the substrate 51 is fixed to the conveyor bed 64 and the conveyor bed 64 moves in a direction of the arrow r. When the substrate 51 reaches the inkjet printing unit 62, as illustrated in FIG. 9, the inkjet printing unit 62 ejects the ultraviolet curable ink 61 to the space between lenses 52 from above of the substrate 51 that is moving in the direction of the arrow r. As illustrated in FIG. 10, when the substrate 51 reaches the ultraviolet irradiating unit 63 as the conveyor bed 64 moves, the first irradiating section 63a irradiates ultraviolet light 67 onto the ultraviolet curable ink 61 from above the lens surface 51a, and the second irradiating device 63b irradiates ultraviolet light 68 to the inside of the substrate 51 from the side plane 51b of the substrate 51.

The ultraviolet light 67 from the first irradiating section 63a cures the ultraviolet curable ink 61, which is ejected onto the lens surface 51a, from the surface side. As illustrated FIG. 7, the ultraviolet light 68 from the second irradiating section 63b irradiates the ultraviolet curable ink 61 from the inside of the substrate 51 and cures the ultraviolet curable ink 61 from the side of lens surface 51a toward the surface of the ultraviolet curable ink 61. Even if the ultraviolet light 67 from the first irradiating section 63a is blocked by the ultraviolet curable ink 61 itself, and the ultraviolet light 67 is unable to reach the lens surface 51a sufficiently, the ultraviolet curable ink 61 can be cured sufficiently from the side of the lens surface 51a on the back surface of the ultraviolet curable ink 61, by the ultraviolet light 68 irradiated from the second irradiating section 63b irradiated inside of the substrate 51.

Accordingly, after the substrate 51 moves past the ultraviolet irradiating unit 63, the ultraviolet curable ink 61 is sufficiently cured by the ultraviolet light 67 and the ultraviolet light 68, and then the lens array 50 having the light-blocking film 53 formed between the lenses 52 with sufficient hardness is produced (FIG. 11). When the property of the light-blocking film 53 that is formed at the lens surface 51a was tested by pencil hardness (2B), a scratch was not formed. Thus, the light-blocking film 53 was proven to have sufficient hardness.

In contrast to this, as a comparison, when the ultraviolet light 67 was irradiated onto the ultraviolet curable ink 61 discharged on the substrate 51 only from the top surface from the first irradiating section 63a in order to attempt curing, an ultraviolet curable ink film for comparison of about 24 μm thick had a scratch formed by a (2B) pencil and proved not to have sufficient hardness.

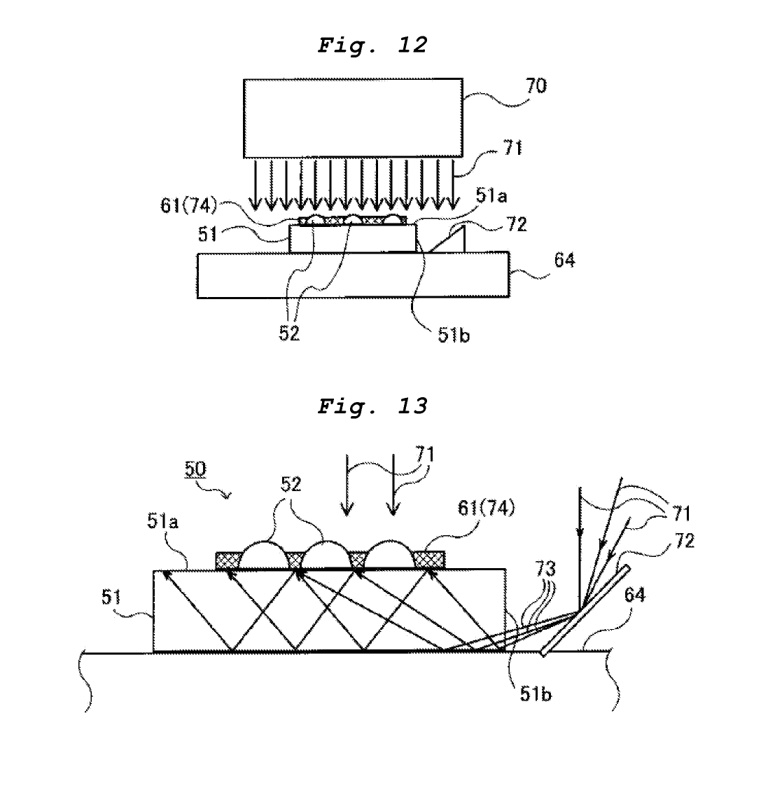

The incidence angle of the ultraviolet light 68 by the second irradiating section 63b toward the inside of the substrate 51 from the side plane 51b (FIG. 12) of the substrate 51 is not restricted, as long as the ultraviolet light 68 can irradiate the ultraviolet curable ink 61 from the backside of the lens surface 51a side. Also, the lens array 50 has the lens surface 51a as one major side of the substrate 51 with a plurality of lenses 52, a lens array can have a lens surface at both major sides of a substrate. Ultraviolet curable ink can be cured sufficiently by irradiating ultraviolet light from the side plane 51b of a substrate, even if a lens surface is provided at both major sides.

According to the first embodiment, the ultraviolet light 68 is irradiated by the second irradiating section 63b from the side plane 51b of the substrate 51. The ultraviolet curable ink 61 on the lens surface 51a is cured from both sides by the ultraviolet light 67 from above and the ultraviolet light 68 from the side plane 51b directed to the lower side of the ultraviolet curable ink 61. Even if the ultraviolet light 67 from the first irradiating section 63a is blocked from reaching the entire volume of the light curable material by the ultraviolet curable ink 61 itself, it is possible to cure the ultraviolet curable ink 61 by irradiating the ultraviolet light 68 from the side plane 51b of the substrate 51 and thus irradiate the side of the up curable layer in contact with the underlying substrate 51.

### Second Embodiment

A second embodiment will be explained next. In the second embodiment, ultraviolet light irradiated from an ultraviolet irradiating unit is reflected toward the side plane of a substrate and then ultraviolet light irradiates ultraviolet curable ink from the side surface of a substrate. In the second embodiment, identical references will be used for identical configurations described in the first embodiment.

As illustrated in FIG. 12, an ultraviolet irradiating unit 70 in the second embodiment irradiates ultraviolet light 71 from above the lens surface 51a to the ultraviolet curable ink 61 that is ejected onto the lens surface 51a of the substrate 51. The conveyor bed 64 provides a mirror 72 adjacent to the substrate 51. The irradiating area of the ultraviolet irradiating unit 70 covers the areas of the ultraviolet curable ink 61 and the mirror 72. The mirror 72 reflects the ultraviolet light 71 irradiated from the ultraviolet irradiating unit device 70 towards the side plane 51b of the substrate 51.

When the substrate 51, having the ultraviolet curable ink 61 formed on the lens surface 51a and in the spaces between lenses 52 of the lens surface 51a (as described above), reaches the ultraviolet irradiating unit 70, the ultraviolet irradiating unit 70 irradiates the ultraviolet light 71 from above the lens surface 51a while moving in a direction of the arrow r. The ultraviolet light 71 from above the substrate 51 travels toward the surface of the ultraviolet curable ink 61 (toward the lens surface 51a) and cures the ultraviolet curable ink 61 from the surface side. Ultraviolet light 73 that is reflected, by the mirror 72 positioned adjacent a side of the substrate 51, toward the side plane 51b of the substrate 51 enters from the side plane 51b into the body of the substrate 51.

After being reflected by the mirror 72, the ultraviolet light 73 enters from the side plane 51b of the substrate 51 into the body of the substrate 51, is reflected toward the backside of the lens surface 51a by internal reflection within the body of the substrate 51 to thereby cure the ultraviolet curable ink 61 from the backside of the lens surface 51a, as illustrated in FIG. 13. Even if the ultraviolet light 71 cannot sufficiently reach the lens surface 51a from above due to a blockage of ultraviolet light 71 by the ultraviolet curable ink 61 itself, the ultraviolet curable ink 61 can be cured sufficiently from the backside of the lens surface 51a side by the ultraviolet light 73 that is reflected back and enters from the side plane 51b of the substrate 51.

The ultraviolet curable ink 61 cures sufficiently by the ultraviolet light 71 and the ultraviolet light 73 that is reflected back, and successfully forms a 24 μm thick light-blocking film 74 on the substrate 51 surface and between the lenses 52 with sufficient hardness. The thickness of 24 μm for the light-blocking film 74 is an example and the thickness may be greater than or less than 24 μm. The light-blocking film 74 cured by the ultraviolet light 71 and the ultraviolet light 73 that is reflected back, has sufficient hardness without generation of a scratch by a (2B) pencil, similar to the light-blocking film 53 of the first embodiment.

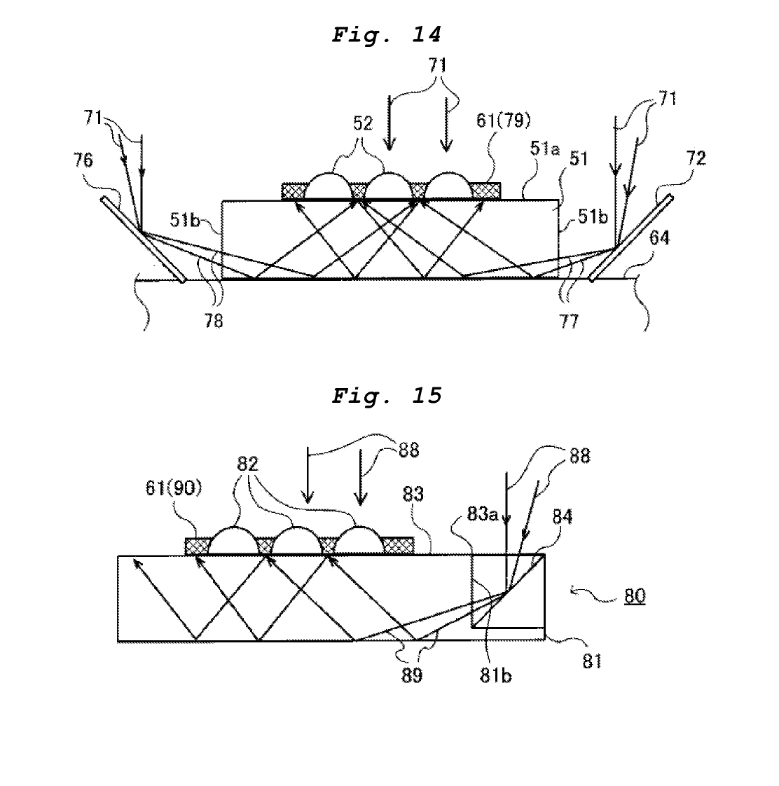

Mirrors can be arranged adjacent to both minor sides of the substrate 51 as illustrated in another example in FIG. 14. In this example, a mirror 76 is provided on the conveyor bed 64 on a side of the substrate 51 opposing the side facing the mirror 72 with the substrate between them. The mirror 72 and the mirror 76 each reflect the ultraviolet light 71 toward the side planes 51b of the substrate. The ultraviolet curable ink 61 on the substrate 51 is irradiated by the ultraviolet light 71 from above of the lens surface 51a, and also irradiated by an ultraviolet light 77 reflected by the mirror 72 and an ultraviolet light 78 reflected by the mirror 76 from the side plane 51b side. The ultraviolet curable ink 61 is cured by ultraviolet light 71 from the top surface toward the lens surface 51a, and the reflected ultraviolet lights 77 and 78 from the lens surface 51a side toward the top surface, and then is able to form a light-blocking film 79 between the lenses 52 with sufficient hardness.

According to the second embodiment, the ultraviolet light 73 reflected by the mirror 72 is irradiated from the side plane 51b of the substrate 51. The ultraviolet curable ink 61 on the lens surface 51a is cured from both side of the upper surface and the lens surface 51a side, by the ultraviolet light 71 and ultraviolet light 73. The ultraviolet curable ink 61 can be sufficiently cured by irradiating the ultraviolet lights 77 and 78 from the side plane 51b of the substrate 51, even in the case the ultraviolet lights 71 from above of the lens surface 51a is blocked by the ultraviolet curable ink 61 itself.

### Third Embodiment

A third embodiment will be explained next. In the third embodiment, ultraviolet light irradiated from an ultraviolet irradiating unit is reflected toward the side plane of a substrate by a protruding plane of a substrate and then the ultraviolet light irradiates the ultraviolet curable ink from the side of a substrate. In the third embodiment, identical references will be used for identical configurations described in the first and second embodiments.

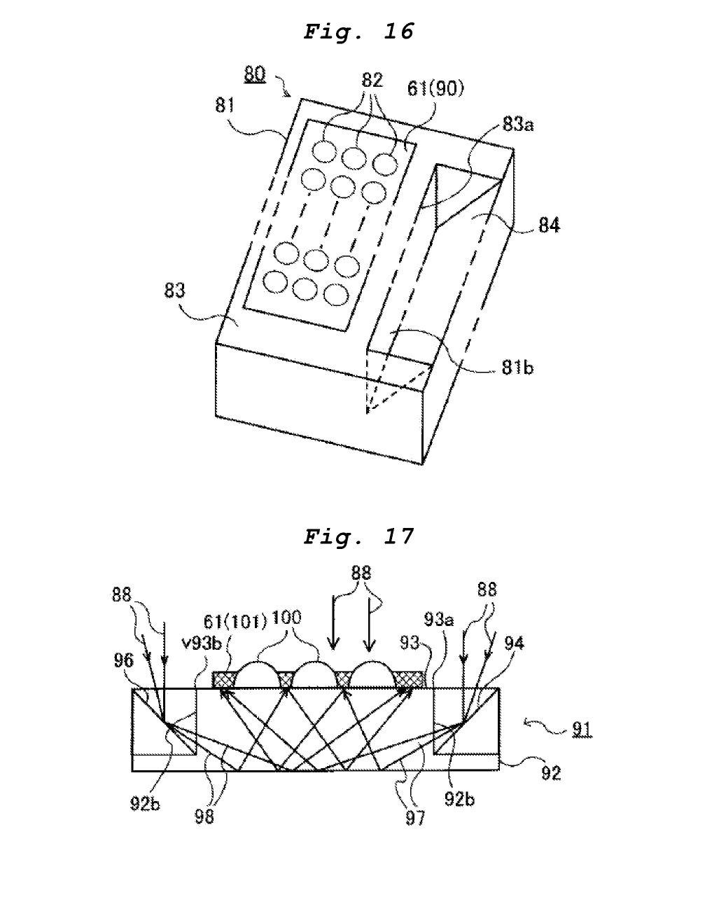

As illustrated in FIG. 15 and FIG. 16, a lens array 80 of the third embodiment has an extended side, such that an inclined reflector may be formed integrally therewith, the inclined plane providing the reflector to reflect the uv light used to cure the light blocking film from the interior of the substrate 51. The inclined reflector 84 is formed as a declining plane 84 extending from an edge of the extended portion of the substrate into the body of the substrate from the lens surface 83 and in the direction of the individual lenses 82 on the surface 83. The declining plane terminates in an emend portion 83a extending generally perpendicularly from the lens surface 83 inwardly of the lens adjacent to the lenses 82. The lens surface 83 includes a plurality of lenses 82 disposed on a transparent substrate 81. The lens array 80 has a light-blocking film 90 formed on the surface thereof between lenses 82 on the lens surface 83. A declining plane is not restricted to a planar inclination, and it can be spherical or corrugated.

The substrate 81 having the declining plane 84 and a plurality of lenses 82 are formed by molding, for example. Upon forming a light-blocking film as described above, and depositing the film between the lenses 82 on the lens surface 83, an ultraviolet irradiating unit (not shown-similar to the ultraviolet irradiating unit 70 described in FIG. 12) irradiates an ultraviolet light 88 from above the lens surface 83 to the ultraviolet curable ink 61. An area of ultraviolet irradiation by the ultraviolet irradiating unit covers areas of the ultraviolet curable ink 61 ejected on the substrate 81 as well as the declining plane 84 of the substrate 81. The declining plane 84 reflects the ultraviolet light 88 irradiated from the ultraviolet irradiating unit toward a side plane 81b of the substrate 81. Ultraviolet light 89 reflected by the declining plane 84 irradiates inside the body of the substrate 81 from the side plane 81b of the substrate 81.

While moving the substrate 81 relative to the ultraviolet irradiating unit as described in FIGS. 6-11, but excluding the second illumination device 63b, directs ultraviolet light 88 from above the lens surface 83 to the ultraviolet curable ink 61 on the lens surface 83, and cures the ultraviolet curable ink 61 from the upper surface side. The ultraviolet light 89 that is reflected back by the declining plane 84 of the substrate 81 toward the side plane 81b of the substrate 81 enters from the side plane 81b into the body of the substrate 81.

After entering from the side plane 81b of the substrate 81 into the body of the substrate 81, the ultraviolet light 89 reflected by the declining plane 84 is reflected toward the lens surface 83 and cures the ultraviolet curable ink 61 from the lens surface 83 backside within the body and toward the surface. Even if the ultraviolet light 88 from above the lens surface 83 cannot sufficiently reach the lens surface 83 due to a blockage of the ultraviolet light 88 by the ultraviolet curable ink 61 itself, the ultraviolet curable ink 61 can be cured sufficiently from the lens surface 83 backside to the surface by the ultraviolet light 89 that is reflected by the declining plane 84 of the substrate 81 to the inside of the body of the substrate 81.

The ultraviolet curable ink 61 cures sufficiently by the ultraviolet light 88 and the ultraviolet light 89 that is internally reflected on the back side thereof, and successfully forms the light-blocking film 90 between the lenses 82 with sufficient hardness. The light-blocking film 90 cured by the ultraviolet light 88 and the ultraviolet light 89 that is internally reflected, is sufficiently hard to not be scratched by a (2B) pencil, which is similar to the light-blocking film 53 of the first embodiment.

The declining plane can comprise declining planes 94 and 96 that extend inwardly of the lens surface from both end portions 93a and 93b, respectively, of the lens surface 93 of a substrate 92 of a lens array 91 as illustrated as an example in FIG. 17. The declining planes 94 and 96 reflect ultraviolet light 97 and 98, which are each reflected ultraviolet light 88 from above a substrate 92. The reflected ultraviolet light 88 is provided toward a side plane 92b of the substrate 92, and then enters from the side plane 92b to inside of the substrate 92. After entering the body of the substrate 92 from the side plane 92b, each ultraviolet light 97 and 98 is reflected toward the lens surface 93 and cures the ultraviolet curable ink 61 from the lens surface 93 backside toward the surface. The ultraviolet curable ink 61 is cured by the ultraviolet light 88 from the lens surface 93 side toward the top surface and the reflected ultraviolet lights 97 and 98 from the lens surface 93 backside toward the top surface, and successfully forms a light-blocking film 101 between a plurality of lenses 100 with sufficient hardness.

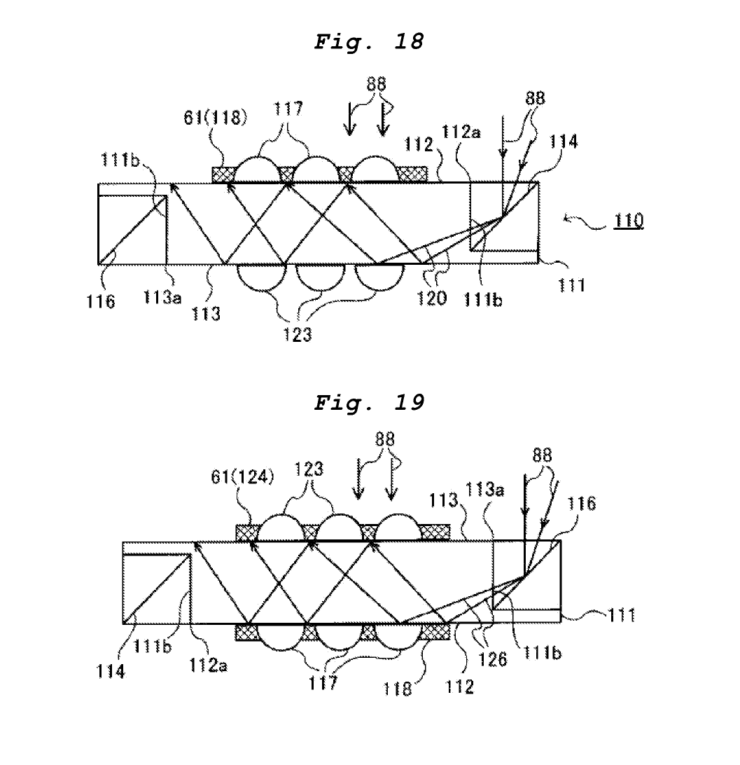

As illustrated as another example in FIG. 18 and FIG. 19, a lens surface can be a substrate 111, which has a first lens surface 112 and a second lens surface 113 on both major sides of the substrate 111 to form a lens array 110. The lens array 110 has a protruding plane 116 that protrudes from an end portion 112a of the first lens surface 112.

For the lens array 110, a light-blocking film 118 on the side of the first lens surface 112 having a plurality of lenses 117 is produced first. As illustrated in FIG. 18, the ultraviolet curable ink 61 that has been deposited in the spaces between the lenses 117 of the first lens surface 112 while moving as described in FIGS. 6-11, is moved relative to a light irradiating unit (not shown). The ultraviolet light 88 is irradiated to the side of the first lens surface 112 by an ultraviolet irradiating unit similar to the light irradiating unit 70 shown in FIG. 12. A declining plane 114 of the substrate 111 redirects ultraviolet light 120 (reflected ultraviolet light 88) in a direction of a side plane 111b of the substrate 111, and from the side plane 111b to the inside of the body of the substrate 111. After entering from the side plane 111b, the ultraviolet light 120 is reflected onto the backside of the first lens surface 112 and cures the ultraviolet curable ink 61 from the backside of the first lens surface 112 toward the surface. The ultraviolet curable ink 61 is cured from the upper surface toward the first lens surface 112 by the ultraviolet light 88 from above and also from the backside of the first lens surface 112 utilizing the reflected ultraviolet light 120, and then successfully forms the light-blocking film 118 between the lenses 117 with sufficient hardness.

After forming the light-blocking film 118, the substrate 111 is inversed (flipped) in order to produce a second insulating film 124 on the side of the second lens surface 113 having a plurality of lenses 123. As illustrated in FIG. 19, the substrate 111 having the ultraviolet curable ink 61 that has been deposited in the spaces between the lenses 123 of the second lens surface 113 as described in FIGS. 6-11, is moved relative to the light irradiating unit (not shown-similar to the light irradiating unit 70 shown in FIG. 12), and the ultraviolet light 88 is irradiated onto the side of the lens surface 113. The declining plane 116 redirects ultraviolet light 126 (reflected ultraviolet light 88) in a direction of a side plane 111b of the substrate 111, and enters from the side plane 111b to inside of the substrate 111. After entering the side plane 111b, the ultraviolet light 126 is reflected on the backside of the second lens surface 113 and cures the ultraviolet curable ink 61 from the backside of the second lens surface 113 toward the surface. The ultraviolet curable ink 61 is cured from the upper surface toward the second lens surface 113 by the ultraviolet light 88 from above and also from the backside of the second lens surface 113 toward the upper surface using the reflected ultraviolet light 126, and then successfully forms the light-blocking film 124 between the lenses 123 with sufficient hardness.

According to the third embodiment and the examples of the third embodiment, ultraviolet light 89, 120, 126 reflected by the declining plane 84, 114, 116 is irradiated from the side plane 81b, 111b of the substrate 81, 111. The ultraviolet curable ink 61 on the lens surface 83, 112, 113 is cured from both sides of the upper surface side and the side surface of the lens surface 83, 112, 113, by the ultraviolet light 88 and ultraviolet light 89, 120, 126. The ultraviolet curable ink 61 can be sufficiently cured by irradiating the ultraviolet light 89, 120, 126 from the side plane 81b, 111 of the substrate 81, 111, even when the ultraviolet light 88 from above the lens surface 83 is blocked by the ultraviolet curable ink 61 itself.

According to at least one of above embodiments, an ultraviolet curable ink, which is supplied to the space between a plurality of lenses of a lens array, can be cured sufficiently by ultraviolet light irradiated from a side plane of a substrate.

The present disclosure is not restricted to the above embodiments and may be embodied in a variety of other forms. Placement configuration and others of a plurality of lenses is optional, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lens, comprising:
A lens body and a lens array formed on a first surface thereof;
a substrate having a lens surface with a plurality of lenses, and an extending plane that extends inwardly of the first surface adjacent to an end portion of the lens surface; and
a light-blocking film provided on the first surface between the plurality of lenses on the lens surface.

2. The lens array according to claim 1, wherein the declining plane redirects light from above the lens surface through a side of the lens surface to the inside of the substrate.

3. The lens array according to claim 2, wherein the declining plane has a surface that is inclined relative to a plane of the lens surface.

4. The lens array according to claim 3, wherein the substrate has the lens surface on two opposing sides thereof.

5. The lens array according to claim 4, wherein the declining plane is formed on both sides of the substrate.

6. The lens array according to claim 1, wherein the declining plane has a surface that is inclined relative to a plane of the lens surface.

7. The lens array according to claim 6, wherein
the declining plane redirects light from above the lens surface through a side of the lens surface to an interior of the substrate.

8. The lens array according to claim 6, wherein the substrate has the lens surface on two opposing sides thereof.

9. The lens array according to claim 8, wherein the declining plane is formed on both sides of the substrate.

10. The lens array according to claim 1, wherein the substrate has the lens surface on two opposing sides thereof.

11. The lens array according to claim 10, wherein the declining plane is formed on both sides of the substrate.

12. An image forming device, comprising:
a light source that irradiates light; and
a lens array, comprising:
a substrate having a lens surface with a plurality of lenses, and a protruding plane that extends from an end portion of the lens surface; and
a light-blocking film provided between the plurality of lenses on the lens surface.

13. The image forming device according to claim 12, wherein the protruding plane has a surface that is inclined relative to a plane of the lens surface.

14. The image forming device according to claim 12, wherein the protruding plane is formed on both sides of the substrate.

15. A method for manufacturing a lens array comprising:
depositing an ultraviolet curable ink onto the surface of a substrate and between a plurality of lenses that are formed on a lens surface of the substrate; and
irradiating ultraviolet light to the inside of the substrate from a side plane of the substrate to cure the ultraviolet curable ink.

16. The method according to claim 15, wherein the irradiated ultraviolet light is redirected from above the lens surface toward the side plane of the substrate to the inside the substrate.

17. The method according to claim 15, further comprising:
irradiating ultraviolet light from above the lens surface toward an upper surface of the lens surface.

18. The method according to claim 17, wherein the irradiated ultraviolet light is redirected from above the lens surface toward the side plane of the substrate to the inside the substrate.

19. The method according to claim 15, further comprising:
irradiating ultraviolet light to the inside of the substrate from two side planes of the substrate to cure the ultraviolet curable ink.
